(19) United States
(12) Patent Application Publication
(10) Pub. No.: US 2025/0337167 A1
(43) Pub. Date: Oct. 30, 2025

(54) Method for Producing a Filling for a Horn Antenna, Horn Antenna for a Radar Measuring Device and Radar Measuring Device

(71) Applicant: VEGA Grieshaber KG, Wolfach (DE)

(72) Inventors: Klaus Kienzle, Zell Am Harmersbach (DE); Johannes Falk, St. Georgen (DE); Fritz Lenk, Schiltach (DE)

(21) Appl. No.: 19/187,297

(22) Filed: Apr. 23, 2025

(30) Foreign Application Priority Data
Apr. 24, 2024 (EP) 2412273.5

(51) Int. Cl. H01Q 13/02

(52) U.S. Cl. CPC H01Q 13/0283; H01Q 13/0208

(57) ABSTRACT

A method for producing a filling for a horn antenna for a radar measuring device, in which the filling has at least one first material composition and a second material composition, which differs from the first material composition. At least the first material composition is provided for the formation of a first section of a raw filling. At least the second material composition is provided for the formation of at least one second section of the raw filling. The second section differs from the first section. The sections of the raw filling are pressed or sintered. A radar measuring device using a horn antenna with such a filling is also disclosed.

The invention relates to a method for producing a fill for a horn antenna for a radar measuring device, a horn antenna for a radar measuring device and a radar measuring device with a horn antenna.

Radar measuring devices, for example radar filling level measuring devices, which detect a filling level of a filling material located in a container, in particular of liquids and bulk materials, according to the propagation time principle, are known from the prior art. Such radar filling level measuring devices have, for example, horn antennas, via which a coupled-in HF signal is emitted in the direction of the filling material and is reflected by it. In a combined sending and receiving system of the radar filling level measuring device, which is coupled to the horn antenna, the microwave pulses reflected by the filling material are detected and evaluated. A conclusion to the filling level of the filling material can be drawn by means of propagation time determination.

Horn antennas generally have a simple and robust setup, a very good efficiency and can be produced cost-efficiently. Horn antennas, in the case of which the antenna horn is completely filled with a solid medium, e.g., a plastic, exist for specific applications, for example negative or positive pressure environments. In the case of such filled horn antennas, it is considered to be disadvantageous, however, that the plastics used for the filling often have insufficient dielectric properties and are additionally not sufficiently suitable for sufficiently withstanding aggressive measuring environments or for being used in hygiene-critical applications, in the case of which cleaning processes with high temperatures are provided.

Previous approaches, as in the EP 3 168 580 A1, thus turn to horn antennas, which have fillings, which comprise several sections with at least partly different materials. The individual sections of the fillings can have different properties thereby, depending on the respective needs. For example, a specific plastic can be selected in the region of the emission surface of the horn antenna, so that the signal characteristic is improved. A different section, in turn, can have a particularly high mechanical stability, so that the horn antenna can be mechanically fastened in the region of this section.

However, the several sections are produced separately. The production effort is high thereby because the interfaces of the sections have to be processed in a complex manner, in order to provide for a gap-free joint. Air gaps between the interfaces would otherwise cause signal reflections, which significantly interfere with the signal, which is to be sent or to be received, and which can thus in particular increase the antenna ringing at close range and reduce the measuring certainty thereby.

Even if a gap between the interfaces can be avoided, at least one individual interface is thus present between the sections due to the separate production of the sections. However, signal reflections likewise occur on interfaces, whereby the quality of the signal transmission of the horn antenna is reduced and the measuring accuracy is thus reduced.

There is thus a need for avoiding or at least reducing the disadvantages of the known fillings for horn antennas. A filling for a horn antenna and a corresponding production method is to in particular be created, which provide for desired properties and which nonetheless ensure a high signal transmission quality.

### SUMMARY OF THE INVENTION

The object is solved by means of the subject matters of the independent patent claims. Advantageous designs are specified in the dependent patent claims and the following description, each of which can represent aspects of the disclosure either separately or in (sub-) combination. Some features are explained with regard to methods, others with regard to devices. However, the aspects are to be applied mutually in each case.

According to one aspect, the invention relates to a method for producing a filling for a horn antenna for a radar measuring device. The filling has at least one first material composition and a second material composition, which differs from the first material composition. The method comprises at least the steps of:
At least the first material composition is provided for the formation of a first section of a raw filling.
At least the second material composition is provided for the formation of at least one second section of the raw filling. The second section differs from the first section.
The sections of the raw filling are pressed or sintered.

The invention is based on the knowledge that one-piece fillings for horn antennas can be produced by means of pressing or sintering. The method makes it possible to provide smooth transitions between different sections of the filling. As a result, interfaces within the filling can be avoided. Signal reflections can be avoided thereby. This is why the quality of the signal transmission rises due to the filling of the horn antenna. For example, fewer interferences and signal losses occur. In addition, the production effort of the filling is reduced compared to previous approaches because gaps between the sections, for example air gaps, can be avoided without complex processing due to the type of the production. In addition, the sections can have desired properties, in order to realize, for example, particularly designed beam characteristics or a high mechanical stability in a certain section.

The raw filling optionally already forms the finished filling for the horn antenna. No further processing of the raw filling is then necessary.

In some embodiments, the method additionally comprises the step of:
heat treating the raw filling.

Due to the heat treatment, the raw filling can be brought, for example, into a mechanically stable and resilient form, so that the structure of the raw filling is permanent, following the heat treatment.

A material concentration of a first material in the first section is preferably larger than a predetermined first threshold value.

Alternatively, or cumulatively, a material concentration of a second material in the second section is larger than a predetermined second threshold value.

This means that the sections can have different material concentrations of the different materials, so that different properties of the sections are ensured.

The first threshold value and/or the second threshold value can be, for example, 50%, preferably 70%, more preferably 85%, more preferably 95%, more preferably 99%.

In some embodiments, the material concentration of the first material in the first section and/or the material concentration of the second material in the second section can be so high that materials other than the respective materials cannot be detected in the respective sections. This means that the first section can, for example, be formed essentially from the first material. Even though the second material is present in the raw filling, for example in the second section, the material concentration of the first material in the first section is so high that the second material cannot be detected in the first section.

Optionally, the method additionally comprises the step of:
mechanical processing of the raw filling, in order to obtain the filling of the horn antenna.

The raw filling, for example of a desired form, can be processed accordingly thereby, so that the raw filling processed in this way can be used as filling of the horn antenna. The horn antenna can have, for example, an outer jacket, for example a rubber coating or a plastic jacket, to the inner volume of which the raw filling is adapted. In addition, the mechanical processing can also be used to create moldings or contours.

The raw filling is preferably formed integrally. Interfaces within the raw filling can be avoided altogether thereby. As a result, a high signal transmission quality can be ensured, thus fewer interferences and influences on the transmitted signal.

A transition of a local material composition between the first section and the second section is optionally smooth. The local material composition is understood to be that material composition, which is present in the transition region between the first and the second section. This means that the material composition does not change suddenly, abruptly but changes in a continuous manner between the different material compositions. The homogeneity of the material transition is increased thereby.

In some embodiments, the method additionally comprises the step of:
providing at least the first material composition and/or the second material composition and/or a third material composition, which differs from the first material composition and the second material composition, for the formation of at least one third section of the raw filling.

The variability of the raw filling is increased thereby because the raw filling can also have more than two sections and more than two material compositions. For example, a third section can be arranged as transition section between the first section and the second section. The third section can then in particular ensure a smooth material transition between the first section and the second section. Interferences on the transmitted signal can be reduced thereby and the mechanical stability can be increased.

It goes without saying that more than three sections can also be formed.

Transitions of a local material composition between the first section, the second section and the third section are preferably smooth. The local material composition is understood to be that material composition, which is present in the transition region between pairs of the first, the second and the third section or in a transition region between all three sections. This means that the material composition does not change suddenly, abruptly but changes in a continuous manner between the different material compositions. The homogeneity of the material transitions is increased thereby.

The material compositions can optionally have one or several materials. In this respect, a material composition, which only has a single material, is also referred to as material composition in the present case. However, material compositions can preferably also have two, three or more materials. The variability of the raw filling is further increased thereby because the properties of the filling of the horn antenna can be set in a needs-based manner based on the corresponding materials.

Due to such a design of the horn antenna with a filling comprising at least two sections, it can be attained that the first section, which closes the antenna horn on the front side, thus in the main emission direction, can be optimally adapted to the ambient conditions acting on the antenna from the outside, while the at least one second section does not have to meet these boundary conditions.

The first material is advantageously optimized with respect to its thermal, mechanical and/or chemical properties. It is attained in this way that, for example, a high positive and/or negative pressure capability, thermally optimized properties and/or an increased chemical resistance against aggressive media is available. The mechanical properties can further also relate to a thermal expansion coefficient, which can be adapted, for example, to a material of the horn antenna, for example an outer jacket thereof. It can be attained in this way that an antenna horn of the horn antenna and the first section used for covering and optionally also for sealing can thermally expand and contract to the same extent. As a result, the desired coverage and/or sealing effect is not jeopardized by thermal influences.

At least one of the first and of the second material can be selected in such a way that it is optimized with respect to its dielectric properties, in particular with regard to an attenuation in the high-frequency range, for example in the case of frequencies above 5 GHZ. A material combination can be attained in this way, which has properties, which are very good both mechanically and/or chemically as well as dielectrically.

The first material composition and the second material composition can be provided, for example, in powder form. The production method is particularly compact thereby.

In some embodiments, the first material and/or the second material comprise at least two different ones of polytetrafluoroethylene (PTFE), polyetheretherketone (PEEK), polyetheretherketone CF 25 (PEEK CF25) and polyetheretherketone CF 30 (PEEK CF30). The abbreviation CFX thereby describes an additional carbon content in PEEK.

PEEK shows, for example, a high mechanical stability. PTFE, in turn, can be used to optimize the signal characteristic.

In the main emission direction of the horn antenna, the first section preferably has a free surface with convex shape. The free surface is thereby formed, for example, as dielectric lens for the beam formation of the horn antenna.

The first section is optionally formed in a lens-shaped or cone-shaped manner. A convex shape can be ensured particularly easily thereby. In addition, the surfaces of convex structures can also be cleaned easily, whereby the maintenance effort for the horn antenna is reduced.

To increase a mechanical stability, the antenna horn can additionally have a circumferential supporting edge, which extends essentially perpendicular to the main emission direction on the front side. A collar, which extends essentially in the main emission direction, can further be arranged on the supporting edge, whereby the antenna horn, the supporting edge and the collar are preferably formed integrally. With respect to a positive and/or negative pressure stability of the present horn antenna, it can be advantageous when the first section of the filling supports itself on the support edge and thus has an increased pressure absorption capacity in the axial direction. The first section can thereby extend in the main emission direction, for example starting at the supporting edge, and can be supported thereon on the rear side.

At least one section of the raw filling can optionally be configured to form a collar of the filling of the antenna horn. The collar can have a clamping assembly extending inwards in the radial direction. The clamping assembly can comprise a plurality of clamping lugs, which are distributed over the circumference, or a circumferential clamping edge. The assembly of the antenna horn can be simplified thereby.

In some embodiments, at least one of the sections can be formed in such a way that it has one or several moldings. The moldings can be formed in such a way that they protrude beyond an outer contour of the surrounding regions of the section. When inserting the filling into the antenna horn, an air gap can be capable of being formed thereby, for example between the filling (in regions, which do not have any moldings) and a sheath of the antenna horn, for example an outer jacket thereof. This air gap is advantageous from a high-frequency technological aspect and additionally makes it possible that thermally induced expansions of the filling in the radial direction are possible. In addition, the moldings can ensure a centering of the filling within the antenna horn.

According to a further aspect, the invention relates to a horn antenna for a radar measuring device. The horn antenna has a filling, which is produced according to the method as described above herein. The first section and the second section are formed along the longitudinal direction of extension of the horn antenna and/or along the radial direction of the horn antenna.

Due to the fact that the filling is formed integrally, the horn antenna has an excellent signal characteristic, even though the production effort is low.

This also means that the second section can at least partly surround the first section in some embodiments. The first section can be protected, for example, against external influences by the second section thereby.

The first section and the second section can alternatively be arranged next to one another along the longitudinal direction of extension of the horn antenna.

Combinations of the relative alignments of the first section and of the second section are likewise conceivable, in particular when more than two sections are formed within the filling.

The horn antenna optionally has an antenna horn, which radiates in a front-side direction, and a rear-side feed device. The filling fills the horn antenna at least partly and closes it on the front side.

The filling preferably completely fills the antenna horn of the horn antenna perpendicular to a main emission direction in the radial direction of the horn antenna at least in some sections.

According to a further aspect, the invention relates to a radar measuring device with electronics for generating and evaluating high-frequency signals, a feed device for feeding a horn antenna with the high-frequency signals. The horn antenna is formed in the manner as described above herein.

The advantages, which are attained by means of the horn antenna, are also attained in a corresponding manner by means of the radar measuring device.

The radar measuring device can in particular be a radar filling level measuring device. The radar filling level measuring device can be coupled to an evaluation unit or can comprise the latter. The evaluation unit is configured to determine a filling level of a medium in a volume, for example a reservoir, based on a propagation time evaluation of signals, which are sent out by the horn antenna and which are received as a result.

All of the features explained with regard to the different aspects can be combined individually or in (sub-) combination with other aspects.

The disclosure as well as further advantageous embodiments and further developments thereof will be described and explained in more detail below on the basis of the examples illustrated in the drawings, in which:

### BRIEF DESCRIPTION OF THE DRAWINGS

FIG. 1 shows a simplified schematic illustration of a horn antenna with a filling according to one embodiment,

FIG. 2 shows a simplified schematic illustration of a method for producing a filling for a horn antenna according to one embodiment,

FIG. 3 shows a simplified schematic illustration of a horn antenna with a filling according to a further embodiment,

FIG. 4 shows an enlarged cut-out I from the embodiment according to FIG. 1, and

FIG. 5 shows an enlarged cut-out II from the embodiment according to FIG. 1.

### DETAILED DESCRIPTION OF THE DRAWINGS

The below detailed description in combination with the enclosed drawings, in which identical numerals refer to identical elements, is intended as description of different embodiments of the disclosed subject matter and is not to represent the only embodiments. Each embodiment described in this disclosure serves only as example or illustration and should not be interpreted as being preferred or advantageous compared to other embodiments. The illustrative examples contained herein do not claim to be exhaustive and do not limit the claimed subject matter to the exact disclosed forms. Different modifications of the described embodiments can be readily recognized by the person of skill in the art, and the general principles defined herein can be applied to other embodiments and applications, without deviating from the spirit and scope of the described embodiments. The described embodiments are thus not limited to the shown embodiments but have the largest possible field of application, which is consistent with the principles and features disclosed here.

All of the features disclosed below with regard to the exemplary embodiments and/or the accompanying figures can be combined either alone or in any sub-combination with features of the aspects of the disclosure, including features of preferred embodiments, provided that the resulting feature combination is expedient for a person of skill in the art in the field of technology.

For the purposes of disclosure, the wording “at least one of A, B and C” means, for example, (A), (B), (C), (A and B), (A and C), (B and C) or (A, B and C), including all further possible combinations, when more than three elements are listed. In other words, the term “at least one of A and B” generally means “A and/or B”, namely “A” alone, “B” alone or “A and B”.

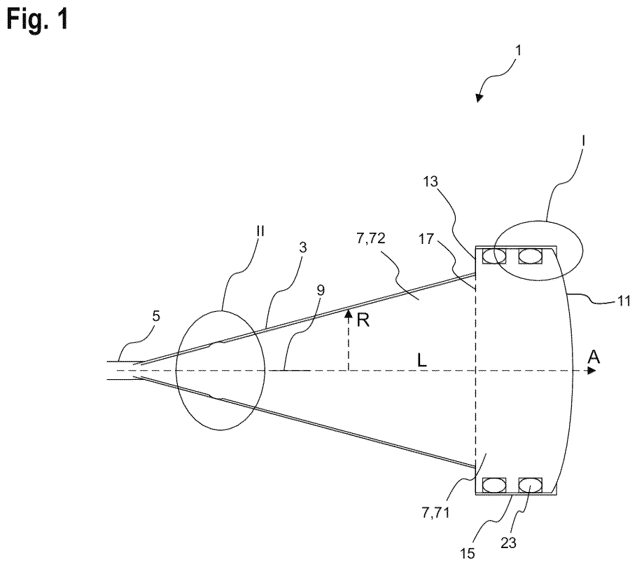

FIG. 1 shows a simplified schematic illustration of a horn antenna 1 with a filling 7 according to one embodiment.

The horn antenna 1 has an antenna horn 3, which is formed in an essentially funnel-shaped manner. A feed device 5 is arranged on the antenna horn 3 on the rear side. The feed device 5 can be, for example, a waveguide connected to the antenna horn 3 or a surface-emitting diode arranged on the end of the antenna horn 3, for example a so-called patch element.

The front-side direction, which corresponds to a main emission direction A of the antenna horn 5, comprises an end, which lies opposite the end, on which the feed device 5 is arranged. A longitudinal direction of extension L of the antenna horn 3 is defined thereby. On the front-side end, the antenna horn 3 has a circumferential supporting edge 13, which extends in the radial direction R, that is, perpendicular to the longitudinal direction of extension L of the antenna horn 3. The supporting edge 13 is molded to the antenna horn 3. This means that the filling 7 also has the supporting edge 13. In a radially running section, the supporting edge 13 continues as a collar 15, which runs in the main emission direction A, because the antenna horn according to this embodiment is formed to be radially symmetrical.

In the present exemplary embodiment, the antenna horn 3, the circumferential supporting edge 13 as well as the collar 15 are formed integrally from a metallic material.

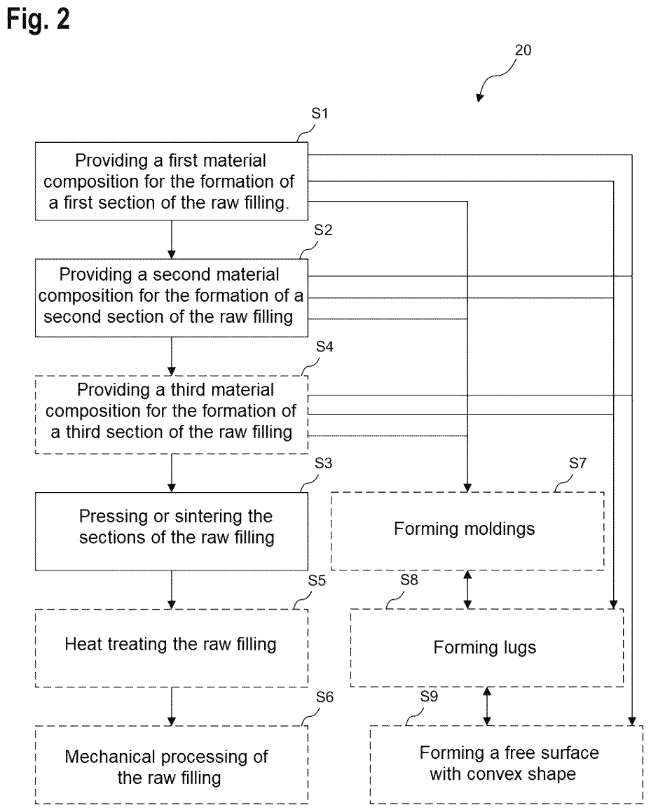

The horn antenna 1 is filled with a filling 7. In this exemplary embodiment, the filling 7 has a first section 71 and a second section 72, which are separated by a (fictitious) interface 17. The interface 17 only represents the boundary between the sections 71, 72 within the filling 7 here. The filling 7 is formed integrally and is produced according to the method from FIG. 2. According to the embodiment from FIG. 1, the first section 71 and the second section 72 are arranged next to one another along the longitudinal direction of extension L.

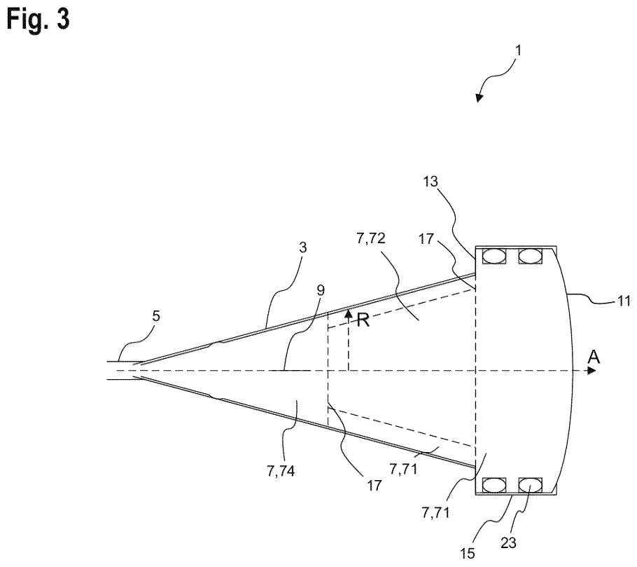

However, the first section 71 and the second section 72 can generally also be arranged next to one another along the radial direction R, which is illustrated in an exemplary manner in the embodiment in FIG. 3. Combinations thereof are also conceivable.

In the present case, the first section 71 is formed from a first material composition, which only has a first material. The material concentration of the first material within the first section 71 is thereby such that other materials therein are negligible or are not even detectable. The material concentration of other materials within the second section 71 is such that said materials therein are negligible or are not even detectable.

The first section 71 closes the horn antenna 1 on the front side in the main emission direction A and supports itself on the circumferential supporting edge 13 on the rear side. The first section 71 is thereby formed so that it (nearly) completely fills a space, which is circumferentially delimited by the collar 15, in the radial direction R, wherein a circumferential seal is provided between the first section 71 and the circumferential collar 15.

In the present exemplary embodiment, the first section 71 has, for this purpose, two grooves running in the circumferential direction, in which sealing elements 23 are arranged. The sealing elements 23 are formed as O rings here. The sealing elements 23 thus seal the first section 71 towards the collar 15, so that an ambient medium cannot penetrate into the interior space of the horn antenna 1.

In the present exemplary embodiment, the first section 71 is formed with a free surface 11 lying in the front in the main emission direction A with convex surface shape. In the case of this exemplary embodiment, the free surface 11 has a lens-shaped design. Spherical and aspherical designs, for example with parabolic profile or conical designs of the free surface 11 are conceivable.

In the exemplary embodiment from FIG. 1, the second section 72 of the filling 7 of a different material composition is arranged on the rear side of the first section 71.

In this exemplary embodiment, the first section 71 is made of PEEK, which forms the first material composition in this respect, which only has a single material thereby. PEEK is a high-performance plastic with high mechanical, thermal and chemical stability. The present horn antenna 1 can be used in this way in environments, to which positive and negative pressure is applied, with chemically aggressive media and high temperature fluctuations.

For example, ceramic polyvinylidene fluoride 30 (PVDF) or polyphenylene sulfide (PPS) are possible as further materials for the first section 71. Further high-performance plastics as well as fiber-reinforced plastics, which can absorb particularly high mechanical stresses, are further possible.

In the present exemplary embodiment, the second section 72 is formed directly from a second material, PTFE in the case at hand, which forms the second material composition in this respect, on the rear side to the first section 71. Compared to PEEK, PTFE has significantly better HF properties (high-frequency properties) and can thus be used in an advantageous manner in a hollow space 9 of the antenna horn 3.

In other embodiments, the second section 72 can be made, for example, of PTFE, polypropylene (PP), polyethylene (PE) or other plastics with suitable high-frequency properties.

The second section 72 fills the hollow space 9 of the antenna horn 3 and reaches to a base of the waveguide, which is arranged on the horn antenna 1 as feed device 5.

FIG. 3 shows a simplified schematic illustration of a horn antenna 1 with a filling 7 according to a further embodiment. Only the differences compared to the embodiment from FIG. 1 are discussed here.

According to this embodiment, the filling 7 has a third section 74. The third section 74 is formed from a third material composition. The third material composition differs from the first and the second material composition.

However, the third section 74 can generally also at least partly be formed from a material, which is also used for the first section 71 or the second section 72.

According to this embodiment, the first section 71 additionally continues along the longitudinal direction of extension L and encloses the second section 72 in the radial direction R. The first section 71 is thus formed as cylinder jacket relative to the second section 72. Other shapes are likewise conceivable.

The interface 17 between the third section 74 and the first section 71 and the second section 72 is again illustrated only for illustration purposes. The filling 7 is formed integrally.

The filling 7 can optionally also have more sections, for example in order to ensure smooth material transitions in terms of gradually changing material concentrations between different sections.

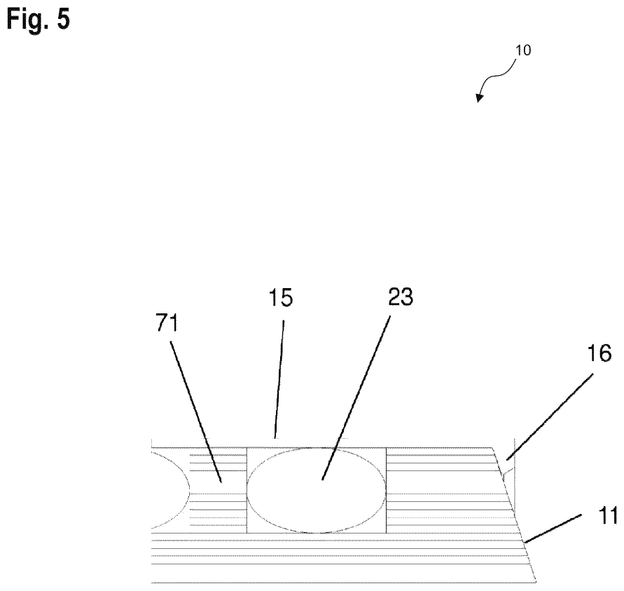

FIG. 5 shows the enlarged cut-out II from the embodiment according to FIG. 1.

The enlarged cut-out II shows that a lug 16, which bulges inwards in the radial direction R, is molded integrally on the collar 15 on the front side in the main emission direction A. A clamping effect is exerted by means of the lug 16 on the first section 71 of the filling 7 and said first section is prevented from moving out of the antenna horn 3. The filling 7 consisting of the first section 71 and the second section 72 is thus fixed in the antenna horn 3. As a result, it can be fastened in a simple way in the antenna horn 3, for example via a snap connection, alternatively via a bayonet connection or the like.

The lug 16 is formed as circumferential web here. Alternatively, it can also be formed as individual lugs, which are distributed over the circumference, preferably at regular intervals. The lugs 16 can be formed integrally with the collar 15 or can be detachably or non-detachably connected thereto. For example, a circumferential snap ring could be attached to the collar 15 on the front side and the filling 7 could thus be fixed in the antenna horn 3.

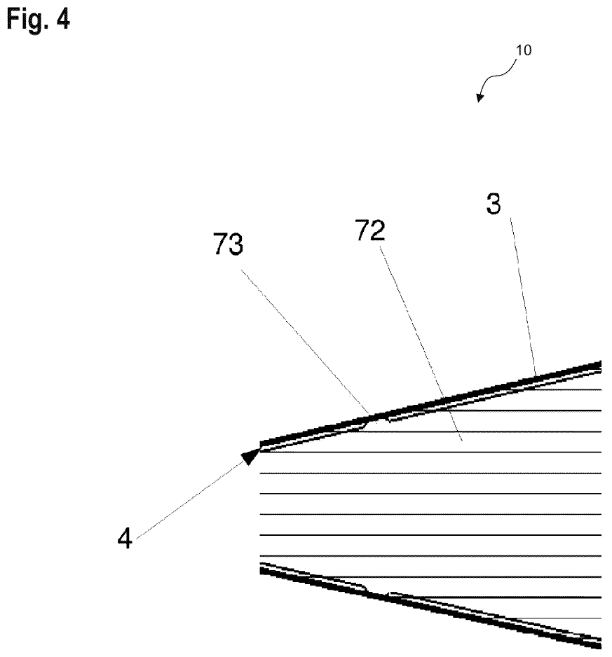

FIG. 4 shows the enlarged cut-out I from the embodiment according to FIG. 1.

The enlarged cut-out I shows that an air gap 4 remains between the antenna horn 3 and the filling 7, the second section 72 of the filling 7 in the present case. This air gap is advantageous from a high-frequency technological view and moreover makes it possible that thermally induced expansions of the filling 7 in the radial direction are possible. For this purpose, the filling 7 has moldings 73 provided in the second section 72, by means of which a defined distance between the filling 7 and the antenna horn 3 is set. This molding also ensures that the filling 72 is always assembled in a centered manner in the antenna horn 3.

Alternatively to moldings 73, an O ring or the like, for example, could also be provided between the antenna horn 3 and the filling 7 for setting the distance.

FIG. 2 shows a simplified schematic illustration of a method 20 for producing a filling 7 for a horn antenna 1 according to one embodiment. Optional steps are illustrated in a dashed manner.

At least the first material composition for the formation of the first section 71 of a raw filling is provided in step S1. The first material composition is in particular provided in powder form. The metering is simple thereby.

At least the second material composition for the formation of at least the second section 72 of the raw filling is provided in the subsequent step S2. The second section 72 differs from the first section 71, for example with regard to the materials and the shape. The second material composition is in particular provided in powder form.

The metering is simple due to the powder form.

A material composition, for example the first material composition, the second material composition or a third material composition is provided in the following optional step S4, in order to form a third section 74 of the raw filling. The third section 74 differs from the first section 71 and the second section 72, for example with regard to the materials, the shape and the position.

In one alternative, the sections 71, 72, 74 can also be formed by individual materials.

The sections 71, 72 (and optionally 74) of the raw filling are pressed or sintered in the following step S4. It is ensured thereby that the raw filling is formed integrally and the shape, composition and position of the sections is permanent.

The method 20 can optionally be further developed, in order to form structural features.

For example, the steps S1, S2, S4 can be formed to that effect that at least one molding is formed in one section 71, 72, 74 according to the optional step S7. A circumferential molding 73, for example, can be ensured thereby, which can be used for the centering of the filling 7 within the antenna horn 3 and for the formation of the air gap 4.

Alternatively, or cumulatively, lugs 16, for example clamping lugs, can also be formed according to step S8, which can be used for the fixation of the filling 7 within the antenna horn 3.

Alternatively, or cumulatively, a free surface 11 can also be formed in at least one of the sections 71, 72, 74 according to step S9, which free surface has a special shape, for example a convex shape. The emission characteristic can thus be defined as desired.

In addition, the method 20 can also be further developed by means of the optional step S5, in which the raw filling is heat treated. This means that the raw filling is heated. This can optionally also take place simultaneously with step S3, thus during the pressing or sintering process. The formation of the filling 7 with the desired shape can be supported thereby.

The method 20 can optionally also be further developed by means of step S6, in which the raw filling is mechanically processed or treated, so that the filling 7 of the horn antenna 1 is maintained. For example, desired moldings 73 can be post-processed or formed by means of the mechanical processing, so that they have the desired shapes.

Reference can be made in this disclosure to quantities and numbers. Unless expressly specified, such quantities and numbers are not to be considered to be limiting but as examples for the possible quantities or numbers in the context of the disclosure. In this context, the term “plurality” can also be used in the disclosure, in order to refer to a quantity or number. In this context, the term “plurality” refers to each number, which is greater than one, e.g., two, three, four, five, etc. The terms “about”, “approximately”, “close to”, etc., mean plus or minus 5% of the specified value.

Even though the disclosure has been illustrated and described with reference to one or several embodiments, the person of skill in the art will be able to make equivalent changes and modifications after reading and understanding this description and the enclosed drawings.
1 horn antenna
3 antenna horn
4 air gap
5 feed device
7 filling
9 hollow space
11 free surface
13 circumferential supporting edge
13 supporting edge
15 circumferential collar
15 collar
16 lug
17 interface
20 method(s)
23 sealing elements
71 first section
72 second section
73 circumferential molding
74 third section
L longitudinal direction of extension
R radial direction
S1-S9 method steps

1. A method for producing a filling for a horn antenna for a radar measuring device, wherein the filling has at least one first material composition and a second material composition, which differs from the first material composition, wherein the method comprises at least the steps of:
providing at least the first material composition for the formation of a first section of a raw filling,
providing at least the second material composition for the formation of at least one second section of the raw filling, which differs from the first section, and
pressing or sintering the sections of the raw filling.

2. The method for producing a filling for a horn antenna according to claim 1, wherein the method additionally comprises:
heat treating the raw filling.

3. The method for producing a filling for a horn antenna according to claim 1, wherein a material concentration of a first material in the first section is larger than a predetermined first threshold value, and/or that a material concentration of a second material in the second section is larger than a predetermined second threshold value.

4. The method for producing a filling for a horn antenna according to claim 1, wherein the method additionally comprises:
mechanical processing of the raw filling, in order to obtain the filling of the horn antenna.

5. The method for producing a filling for a horn antenna according to claim 1, wherein the raw filling is formed integrally.

6. The method for producing a filling for a horn antenna according to claim 1, wherein a transition of a local material composition between the first section and the second section is smooth.

7. The method for producing a filling for a horn antenna according to claim 1, wherein the method additionally comprises
providing at least the first material composition and/or the second material composition and/or a third material composition, which differs from the first material composition and the second material composition, for the formation of at least one third section of the raw filling.

8. The method for producing a filling for a horn antenna according to claim 7, wherein transitions of a local material composition between the first section, the second section and the third section are smooth.

9. The method for producing a filling for a horn antenna according to claim 1, wherein the first material composition and or the second material composition comprise at least two different ones of polytetrafluoroethylene, polyetheretherketone, polyetheretherketone CF 25 and polyetheretherketone CF 30.

10. The method for producing a filling for a horn antenna according to claim 1, wherein in the main emission direction, the first section has a free surface with convex shape.

11. The method for producing a filling for a horn antenna according to claim 1, wherein the first section is formed in a lens-shaped or cone-shaped manner.

12. A horn antenna for a radar measuring device, which has a filling, which is produced according to the method according to claim 1, and wherein the first section and the second section are formed along the longitudinal direction of extension (L) and/or along the radial direction of the horn antenna.

13. The horn antenna according to claim 12, wherein the horn antenna has an antenna horn, which radiates in a front-side direction, and a rear-side feed device, wherein the filling fills the horn antenna at least partly and closes it on the front side.

14. The horn antenna according to claim 13, wherein the filling completely fills the antenna horn of the horn antenna perpendicular to a main emission direction in the radial direction (R) of the horn antenna at least in some sections.

15. A radar measuring device with an electronics for generating and evaluating high-frequency signals, a feed device for feeding a horn antenna with the high-frequency signals, comprising a horn antenna according to claim 12.
